(19) United States
(12) Patent Application Publication
(10) Pub. No.: US 2014/0137023 A1
(43) Pub. Date: May 15, 2014

(54) METHOD FOR VISUALLY MAPPING NETWORK PORTS TO NETWORK INTERFACE CARDS

(71) Applicant: INSTITUTE FOR INFORMATION INDUSTRY, Taipei (TW)

(72) Inventors: Chien-Nan LIN, Tainan City (TW); Chung-Ting KAO, Taipei City (TW)

(73) Assignee: INSTITUTE FOR INFORMATION INDUSTRY, Taipei (TW)

(21) Appl. No.: 13/712,011

(22) Filed: Dec. 12, 2012

(30) Foreign Application Priority Data
Nov. 14, 2012 (TW) 101142335

(51) Int. Cl. G06F 13/40; G06F 3/0484

(52) U.S. Cl. CPC G06F 13/40; G06F 3/04845
USPC 715/771; 710/305

(57) ABSTRACT

A method for visually mapping network ports to network interface cards, applied to a network device having a plurality of network ports and a plurality of network interface cards, is provided. A network port layout corresponding to a configuration of the plurality of network ports on the network device is received. An unplugging order of the plurality of network ports is provided according to the network port layout. Numbers of the plurality of network interface cards are recorded according to an occurrence order of unplugging events occurring in the plurality of network interface cards when unplugging the plurality of network ports according to the unplugging order into an unplugging event record. The numbers of the plurality of network interface cards are combined into the network port layout according to the unplugging event record to generate a network port mapping layout Then the network port mapping layout is displayed.

### CROSS REFERENCE TO RELATED APPLICATIONS

This Application claims priority of Taiwan Patent Application No. 101142335, filed on Nov. 14, 2012, the entirety of which is incorporated by reference herein.

### BACKGROUND OF THE INVENTION

1. Field of the Invention

The invention relates to the technology of identifying the relationship between network ports and network interface cards of a network device.

2. Description of the Related Art

As cloud computing technology develops, the scale of data centers have grown, and thus managing related network devices have become more critical. Many modem network devices, such as a server, a hub, etc., are multi-functional and have multiple network ports and multiple network interface cards. When a network device is connected to different subnets at the same time, identifying which network port corresponds to which network interface card is needed so as to correctly set related network environments and perform other required operations. In a conventional method for identifying network ports, firstly, one of the network ports is suspended or activated through a system command, and then whether a lamp indication of the network port changes is observed so as to determine whether the network port corresponds to the network interface card where the change caused by the system command occurred. However, the steps described above have to be repeated for many times to identify all network ports, and thus it takes a lot of time. In addition, when physical statuses of the network device have changed, such as connection to newly added devices, changes in connection settings or position shifts, the time consuming method may have to be performed again. Moreover, even if the method described above is accomplished, if tags indicating corresponding network interface cards are not stuck on the network ports artificially, a user may easily forget the relationship between the network ports and the network interface cards. Furthermore, since network devices provided by different manufacturers have different methods for setting network ports, the complexity of identifying network ports increases as the number of network devices increase. Accordingly, quickly and efficiently identifying the relationship between the network ports and the network interface cards are important issues in the related field.

### BRIEF SUMMARY OF THE INVENTION

In view of this, an embodiment of the invention provides a method for visually mapping network ports to network interface cards, applied to a network device having a plurality of network ports and a plurality of network interface cards, comprising: receiving a network port layout corresponding to a configuration of the plurality of network ports on the network device; providing an unplugging order of the plurality of network ports according to the network port layout; unplugging the plurality of network ports according to the unplugging order, and recording numbers of the plurality of network interface cards according an occurrence order of unplugging events occurring in the plurality of network interface cards when unplugging into an unplugging event record; combining the numbers of the plurality of network interface cards into the network port layout according to the unplugging event record and generating a network port mapping layout; and displaying the network port mapping layout.

Another embodiment of the invention provides a computer program product embodied in a tangible computer-readable storage medium, wherein when the computer program product is loaded into and executed by a network device having a plurality of network ports and a plurality of network interface cards, the network device performs a method for visually mapping network ports to network interface cards, the computer program product comprising: a first program code for receiving a network port layout corresponding to a configuration of the plurality of network ports on the network device; a second program code for providing an unplugging order of the plurality of network ports according to the network port layout; a third program code for recording numbers of the plurality of network interface cards according an occurrence order of unplugging events occurring in the plurality of network interface cards when unplugging the plurality of network ports according to the unplugging order into an unplugging event record; a fourth program code for combining the numbers of the plurality of network interface cards into the network port layout according to the unplugging event record and generating a network port mapping layout; and a fifth program code for displaying the network port mapping layout.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flow chart of a method for visually mapping network ports to network interface cards according to an embodiment of the invention;

FIG. 2 is a block diagram of a network device according to an embodiment of the invention;

FIG. 3A to FIG. 3D are block diagrams of a method for visually mapping network ports to network interface cards according to an embodiment of the invention;

FIG. 4 is a block diagram of an unplugging event record according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It is to be understood that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

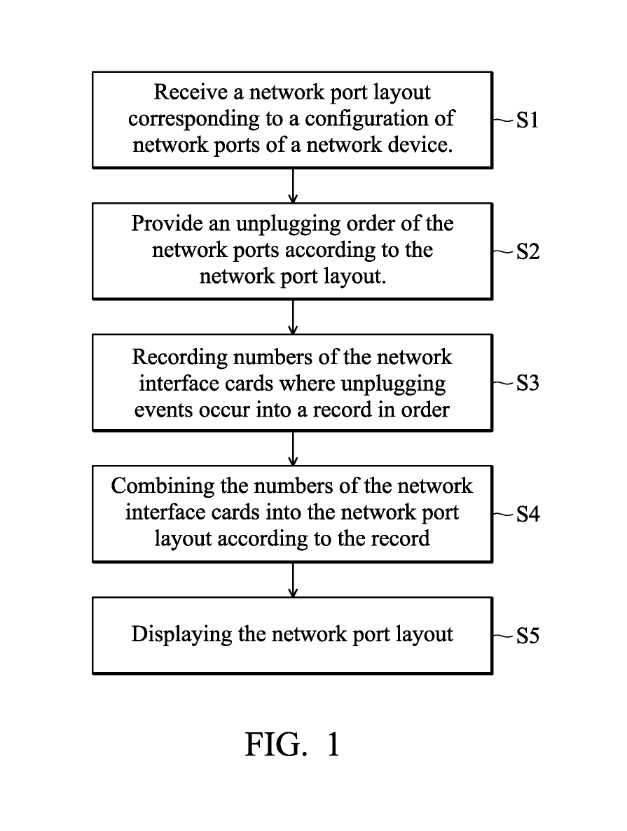

FIG. 1 is a flow chart of a method for visually mapping network ports to network interface cards according to an embodiment of the invention. The method is applied to a network device having a plurality of network ports and a plurality of network interface cards, such as a server.

Firstly, in step S1, a network port layout corresponding to the configuration of the network ports of the network device is received. The network port layout presents how all of the network ports are arranged on the network device visually. The detail of the network port layout will be described later. In step S2, an unplugging order of the network ports is provided according to the network port layout. Then in step S3, when the network ports are unplugged according to the unplugging order, numbers of the network interface cards where unplugging events occur are recorded into a record in order. In step S4, the number of the corresponding network interface card of each network port is combined into the network port layout. In step S5, the network port layout combined with the numbers of the network interface cards is displayed.

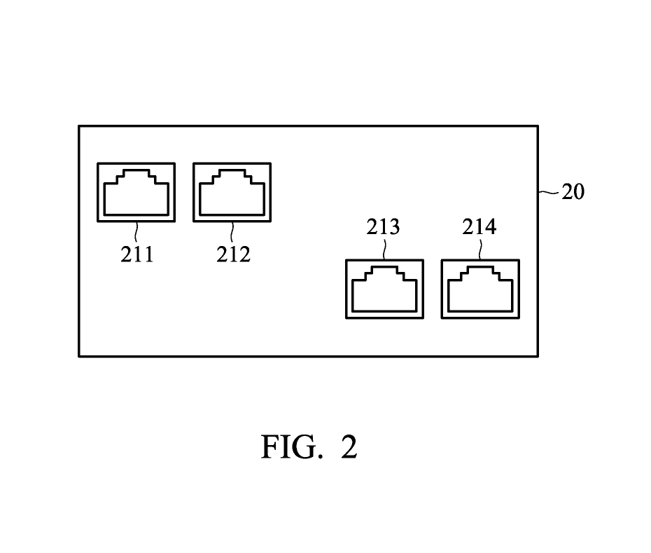

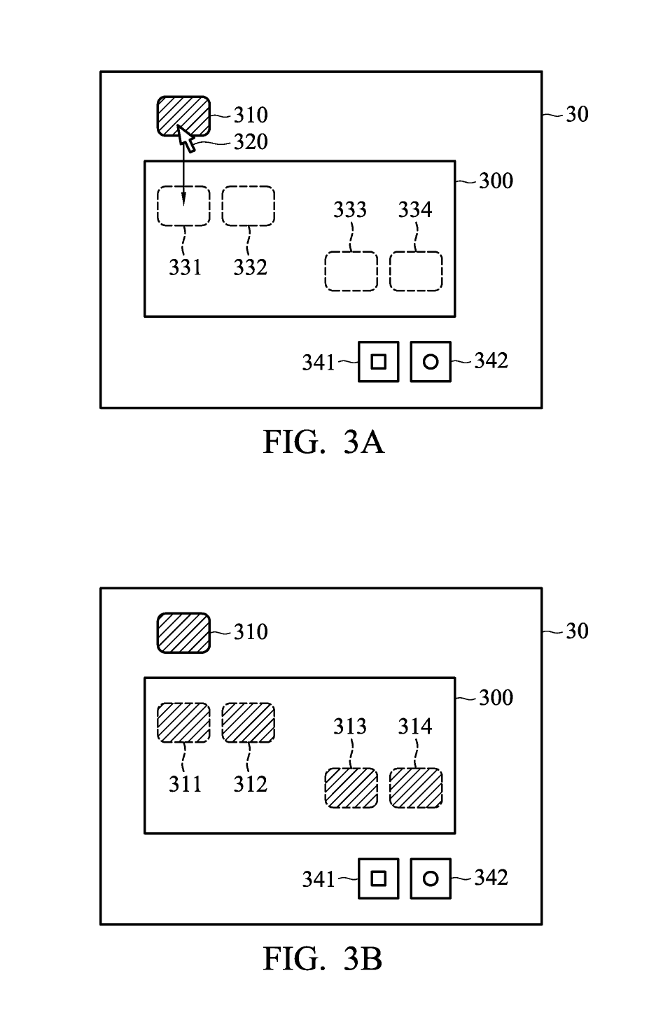

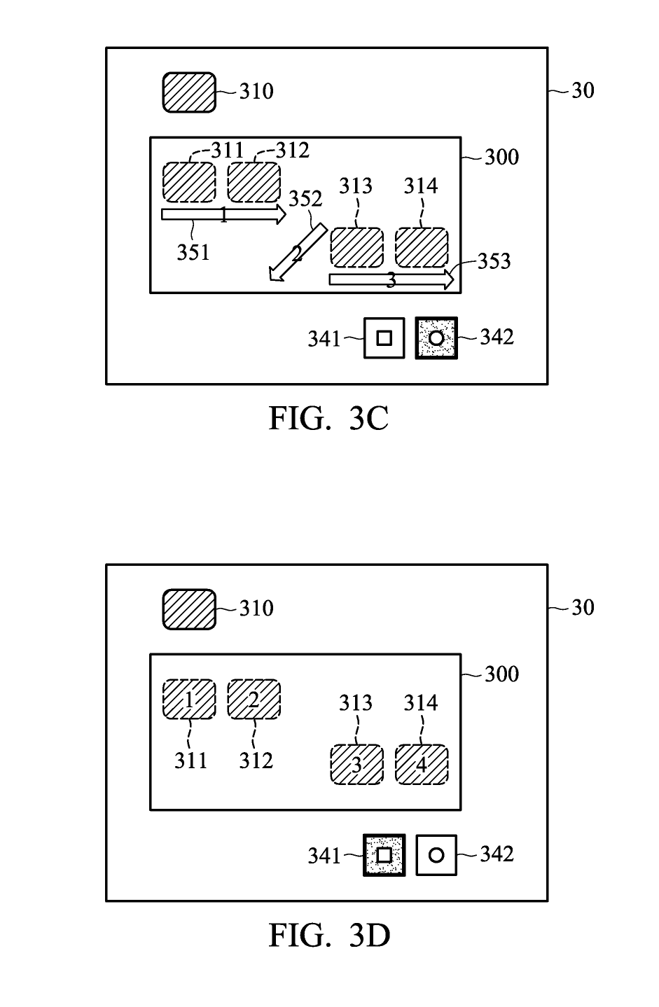

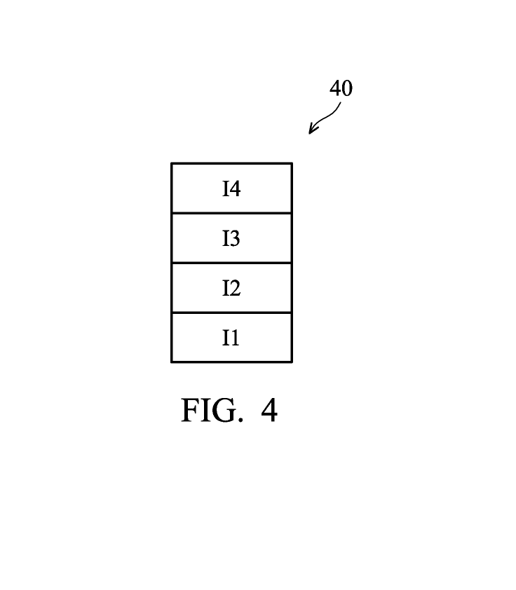

The method for visually mapping network ports to network interface cards will be described in detail with reference to FIG. 2, FIG. 3A˜FIG. 3D and FIG. 4 in the following.

FIG. 2 is a block diagram of a network device 20 according to an embodiment of the invention. The network device 20 comprises network ports 211, 212, 213 and 214. The network ports may be arranged on the back panel of the network device 20. The network device 20 further comprises four network interface cards (not shown in the figure) numbered by 1, 2, 3 and 4, respectively. Note that the number of the network ports and the number of the network interface cards are only exemplary and the invention is not limited thereto. For example, there may be more or less network ports or network interface cards.

FIG. 3A to FIG. 3D are block diagrams of a method for visually mapping network ports to network interface cards according to an embodiment of the invention. Before the method for visually mapping network ports to network interface cards is performed, it is determined whether all network ports 211, 212, 213 and 214 of the network device 20 are connected to network wires and function normally. The method for visually mapping network ports to network interface cards provides a graphical user interface (GUI) 30 which allows users to set the network port layout and displays the visual mapping result of the network ports and the network interface cards to the users. The GUI 30 comprises an operation area 300 for the network port layout, a graphic object key 310 for representing network ports, a pause key 341 and a record key 342. When a user wants to identify the relationship between the network ports and the network interface cards of the network device 20 in FIG. 2, first, as shown in FIG. 3A, the user uses a cursor 320 to select the graphic object key 310. Each time the graphic object key 310 is selected, a graphic object is generated. Generated graphic objects are dragged to be arranged in positions 331, 332, 333 and 334 on the operation area 300, respectively, according to absolute positions and relative positions of the network ports 211, 213, 213 and 214 on the network device 20.

After setting graphic objects according to the configuration of the network ports 211, 213, 213 and 214 on the network device 20, as shown in FIG. 3B, the operation area 300 will comprise the graphic objects 311, 312, 313 and 314, which correspond to the network ports 211, 212, 213 and 214 of the network device 20 in FIG. 2, respectively. That is, the number of the graphic objects on the operation area is equal to the number of the network ports of the network device, and the absolute positions and the relative positions of the graphic objects on the operation area are consistent with the absolute positions and the relative positions of the network ports of the network device.

Then, the user selects the record key 342 to start identifying the relationship between the network ports and the network interface cards. After the record key 342 is selected, first, the GUI 30 stores the graphic objects 311, 312, 313 and 314 on the operation area 300 as a network port layout. After that, as in step S1 of FIG. 1, the network port layout is received. The information about how many network ports the network device 20 has and how the network ports are arranged can be obtained from the network port layout. Next, as in step S2 of FIG. 1, an unplugging order of the network ports is provided according to the network port layout. On the GUI 30, arrows 351, 352 and 353 are used to represent the unplugging order. The arrows 351, 352 and 353 are marked by numbers which represent the order. Therefore, according to the arrows 351, 352 and 353, the unplugging order of the network ports are the network port 211 which the graphic object 311 corresponds to, the network port 212 which the graphic object 312 corresponds to, the network port 213 which the graphic object 313 corresponds to, and the network port 214 which the graphic object 314 corresponds to, in order. Afterwards, the user unplugs the network ports 211, 212, 213 and 214 of the network device 20 according to the unplugging order. When the network ports 211, 212, 213 and 214 are unplugged according to the unplugging order, as in step S3 of FIG. 1, the numbers of the network interface cards are recorded according to an occurrence order of unplugging events occurring in the network interface cards and an unplugging event record is generated. FIG. 4 is a block diagram of the unplugging event record 40 according to an embodiment of the invention. The unplugging event record 40 is in the form of a stack. The bottom end of the stack records the earliest unplugging event, and the upper end of the stack records the last unplugging event. In FIG. 4, I1, I2, I3 and I4 correspond to the numbers of the network interface cards 1, 2, 3 and 4, respectively. For example, when the network port 211 is unplugged first according to the unplugging order, an unplugging event occurs in the network interface card corresponding to the network port 211. When the unplugging event occurring in the network interface card is detected, the number of the network interface card where the unplugging event occurred is recorded. In this example, since the network port 211 is unplugged first according to the unplugging order and the bottom end of the stack records I1 (the earliest unplugging event), the network port 211 corresponds to the network interface card whose number is 1. Similarly, numbers of the network interface cards are recorded sequentially when other network ports are unplugged. It is to be understood that the stack of the unplugging event record 40 described above is only exemplary, and the invention is not limited thereto. Moreover, the unplugging order as shown in FIG. 3C is determined according to a zigzag way, but the invention is not limited thereto. After the network ports are unplugged according to the unplugging order, as shown in FIG. 3D, the pause key is pressed. Then, as shown in steps S4 and S5 of FIG. 1, the number of the corresponding network interface card of each network port is combined into the network port layout according to the unplugging event record, and a network port mapping layout is generated and then displayed. As shown in the operation area 300 of FIG. 3D, the graphic objects 311, 312, 313 and 314 are indicated by numbers of their corresponding network interface cards. Since the unplugging order when the network ports were unplugged is known and the numbers of the network interface cards in the unplugging event record were recorded according to the occurrence order of the unplugging events (corresponding to the unplugging order), the network interface card corresponding to each network port can be obtained from the unplugging event record. For example, according to the unplugging order shown in FIG. 3C and the unplugging event record 40 shown in FIG. 4, the network port 211 represented by the graphic object 311 corresponds to the network interface card with number 1, the network port 212 represented by the graphic object 312 corresponds to the network interface card with number 2, the network port 213 represented by the graphic object 313 corresponds to the network interface card with number 3, and the network port 214 represented by the graphic object 314 corresponds to the network interface card with number 4. Therefore, according to the network port mapping layout in FIG. 3D, the network interface card corresponding to each network port is directly obtained. Since the network port mapping layout can be visually seen to correspond to the actual configuration of the network ports 211, 212, 213 and 214, the user can clearly know the relationship between the network ports and the network interface cards. Moreover, in another embodiment, the network port mapping layout may be stored corresponding to the ID or the number of the network devices, and thus, when a next time an inquiry about the relationship between the network ports and the network interface cards is desired, the user may simply retrieve the stored network port mapping layout to review the relationship between the network ports and the network interface cards.

The GUI described above may be provided by the network device. In another embodiment, the GUI may be provided by a portable electronic device connected to the network device to be identified, such as a tablet computer. The user may create or set a network port layout through the GUI provided by the portable electronic device connected to the network device. The GUI transmits the network port layout to the network device and then the network device performs steps S1 to S4 of FIG. 1. Then, the network device transmits the network port mapping layout to the portable electronic device and displays the network port mapping layout on the GUI provided by the portable electronic device to the user.

Methods and apparatus of the present disclosure, or certain aspects or portions of embodiments thereof, may take the form of a program code (i.e., instructions) embodied in tangible media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

In one embodiment, the method for visually mapping network ports to network interface cards described above may take the form of a computer program product embodied in a tangible computer readable media. When the computer program product is loaded into and executed by a network device having a plurality of network ports and a plurality of network interface cards, the network device performs a method for visually mapping the network ports to the network interface cards. The computer program product comprises: a first program code for receiving a network port layout corresponding to a configuration of the plurality of network ports on the network device; a second program code for providing an unplugging order of the plurality of network ports according to the network port layout; a third program code for recording numbers of the plurality of network interface cards according an occurrence order of unplugging events occurring in the plurality of network interface cards when unplugging the plurality of network ports according to the unplugging order into an unplugging event record; a fourth program code for combining the numbers of the plurality of network interface cards into the network port layout according to the unplugging event record and generating a network port mapping layout; and a fifth program code for displaying the network port mapping layout.

Moreover, the computer program product further comprises: a sixth program code for providing a graphical user interface; a seventh program code for moving the plurality of graphic objects on the graphical user interface by dragging to generate the network port layout; and an eighth program code for displaying the network port mapping layout on the graphical user interface.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for visually mapping network ports to network interface cards, applied to a network device having a plurality of network ports and a plurality of network interface cards, comprising:
receiving a network port layout corresponding to a configuration of the plurality of network ports on the network device;
providing an unplugging order of the plurality of network ports according to the network port layout;
unplugging the plurality of network ports according to the unplugging order, and recording numbers of the plurality of network interface cards according an occurrence order of unplugging events occurring in the plurality of network interface cards when unplugging into an unplugging event record;
combining the numbers of the plurality of network interface cards into the network port layout according to the unplugging event record and generating a network port mapping layout; and
displaying the network port mapping layout.

2. The method as claimed in claim 1, wherein the network port layout comprises a plurality of graphic objects, and each of the plurality of graphic objects corresponds to one of the plurality of network ports, and a configuration of the plurality of graphic objects on the network port layout corresponds to the configuration of the plurality of network ports on the network device.

3. The method as claimed in claim 2, wherein the number of the corresponding network interface card of each network port obtained according to the unplugging event record is combined into the corresponding graphic object of each network port.

4. The method as claimed in claim 2, further comprising:
providing a graphical user interface; and
moving the plurality of graphic objects on the graphical user interface by dragging to generate the network port layout.

5. The method as claimed in claim 4, further comprising:
displaying the network port mapping layout on the graphical user interface.

6. A computer program product embodied in a tangible computer-readable storage medium, wherein when the computer program product is loaded into and executed by a network device having a plurality of network ports and a plurality of network interface cards, the network device performs a method for visually mapping network ports to network interface cards, the computer program product comprising:
a first program code for receiving a network port layout corresponding to a configuration of the plurality of network ports on the network device;
a second program code for providing an unplugging order of the plurality of network ports according to the network port layout;
a third program code for recording numbers of the plurality of network interface cards according an occurrence order of unplugging events occurring in the plurality of network interface cards when unplugging the plurality of network ports according to the unplugging order into an unplugging event record;
a fourth program code for combining the numbers of the plurality of network interface cards into the network port layout according to the unplugging event record and generating a network port mapping layout; and
a fifth program code for displaying the network port mapping layout.

7. The computer program product as claimed in claim 6, wherein the network port layout comprises a plurality of graphic objects, and each of the plurality of graphic objects corresponds to one of the plurality of network ports, and a configuration of the plurality of graphic objects on the network port layout corresponds to the configuration of the plurality of network ports on the network device.

8. The computer program product as claimed in claim 7, wherein the number of the corresponding network interface card of each network port obtained according to the unplugging event record is combined into the corresponding graphic object of each network port.

9. The computer program product as claimed in claim 7, further comprising:
a sixth program code for providing a graphical user interface; and
a seventh program code for moving the plurality of graphic objects on the graphical user interface by dragging to generate the network port layout.

10. The computer program product as claimed in claim 8, further comprising:
an eighth program code for displaying the network port mapping layout on the graphical user interface.
